(19) United States
(12) Patent Application Publication
(10) Pub. No.: US 2026/0115907 A1
(43) Pub. Date: Apr. 30, 2026

(54) METHOD FOR SUPPRESSING VIBRATION OF CONTROL SIGNAL FOR FORCE CONTROL, COMPUTER DEVICE AND READABLE STORAGE MEDIUM

(71) Applicants: SHANGHAI FLEXIV ROBOTICS TECHNOLOGY CO., LTD., Shanghai (CN); FLEXIV LTD., Grand Cayman (KY)

(72) Inventors: Xiyang YEH, Santa Clara, CA (US); Poyen CHEN, Santa Clara, CA (US); Yaohua NIE, Shanghai (CN)

(21) Appl. No.: 18/683,647

(22) PCT Filed: May 26, 2023
(86) PCT No.: PCT/CN2023/096440

§ 371 Date: Feb. 14, 2024

(51) Int. Cl. B25J 9/16; B25J 13/08; G05D 19/02

(52) U.S. Cl. CPC B25J 9/1633; B25J 13/085; G05D 19/02; G05B 2219/39195

(57) ABSTRACT

A method for suppressing vibration of a control signal for force control includes: acquiring a first output signal of a force sensing device, the first output signal including at least one of a force signal and a torque signal; processing, by an analog differential circuit, the first output signal to obtain a second output signal corresponding to a differential component of at least one of the force signal and the torque signal; and suppressing, by using the second output signal, vibration of the control signal for force control.

### TECHNICAL FIELD

The present disclosure relates to the field of robotics, and in particular, to a method for suppressing vibration of a control signal for force control, a computer device and a readable storage medium.

### BACKGROUND

Even in the most well-designed and stiffest robots, flexibilities in joints and links still exist, and vibrations originating from these flexibilities can destabilize the stability of the robots and degrade their performance. In addition, some flexibilities are intentionally added to provide sensing capabilities. For example, in a torque-controlled robot designed to perform contact control, flexible elements are embedded in the system to enable measurement of external forces. These elements can be single-axis torque sensors as on joints and/or six-axis force/torque sensors at an end-effector of the robot. To fully benefit from these additional sensing capabilities during operation and minimize the effects of signal vibration, the system will need to measure and compensate for vibration.

Traditional control methods for suppressing vibration mainly use an inertial measuring unit (IMU) or a joint acceleration as feedback, and these signals are often noisy. Some traditional control methods rely on finite differentiation of forces, but tend to amplify the noise of these signals, resulting in poor performance of the robotic system.

### SUMMARY

Based on this, it is necessary to provide a method for suppressing vibration of a control signal for force control, a computer device, and a non-temporary computer-readable storage medium for the above technical problems.

A first aspect of the present disclosure provides a method for suppressing vibration of a control signal for force control. The method includes: acquiring a first output signal of a force sensing device, the first output signal including at least one of a force signal and a torque signal; processing, by an analog differential circuit, the first output signal to obtain a second output signal corresponding to a differential component of at least one of the force signal and the torque signal; and suppressing, by using the second output signal, vibration of the control signal for force control.

In the first aspect of the present disclosure, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: processing, by a plurality of analog differential circuits, the plurality of measured signals in one-to-one correspondence to obtain differential components of the plurality of measured signals; and calculating, based on the differential components of the plurality of measured signals, to determine the second output signal.

In the first aspect of the present disclosure, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: fusing the plurality of measured signals to obtain one or more fused measured signals; processing, by one or more analog differential circuits, the one or more fused measured signals in one-to-one correspondence to obtain differential components of the one or more fused measured signals; and calculating, based on the differential components of the one or more fused measured signals, to determine the second output signal.

In the first aspect of the present disclosure, the first output signal indicates an output torque of a joint of a robot. The method further includes: acquiring a desired torque of the joint of the robot and a differential component of the desired torque. The suppressing, by using the second output signal, the vibration of the control signal for force control includes: adjusting, based on the desired torque, the differential component of the desired torque and the second output signal, a motor output of the joint of the robot.

In the first aspect of the present disclosure, the first output signal indicates an output force of an end-effector of a robot. The method further includes: acquiring a desired force of the end-effector of the robot and a differential component of the desired force. The suppressing, by using the second output signal, the vibration of the control signal for force control includes: adjusting, based on the desired force, the differential component of the desired force and the second output signal, an output displacement of the end-effector of the robot.

A second aspect of the present disclosure provides a computer device including a processor and a memory storing processor-executable instructions. The processor-executable instructions, when executed by the processor, cause the processor to: acquire a first output signal of a force sensing device, the first output signal including at least one of a force signal and a torque signal; process, by an analog differential circuit, the first output signal to obtain a second output signal corresponding to a differential component of at least one of the force signal and the torque signal; and suppress, using the second output signal, vibration of a control signal for force control.

In the first aspect of the present disclosure, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: processing, by a plurality of analog differential circuits, the plurality of measured signals in one-to-one correspondence to obtain differential components of the plurality of measured signals; and calculating, based on the differential components of the plurality of measured signals, to determine the second output signal.

In the first aspect of the present disclosure, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: fusing the plurality of measured signals to obtain one or more fused measured signals; processing, by one or more analog differential circuits, the one or more fused measured signals in one-to-one correspondence to obtain differential components of the one or more fused measured signals; and calculating, based on the differential components of the one or more fused measured signals, to determine the second output signal.

In the second aspect of the present disclosure, the first output signal indicates an output torque of a joint of a robot. The processor-executable instructions, when executed by the processor, further cause the processor to: acquire a desired torque of the joint of the robot and a differential component of the desired torque. The suppressing, by using the second output signal, the vibration of the control signal for force control includes: adjusting, based on the desired torque, the differential component of the desired torque and the second output signal, a rotor output of the joint of the robot.

In the second aspect of the present disclosure, the first output signal indicates an output force of an end-effector of a robot. The processor-executable instructions, when executed by the processor, further cause the processor to: acquire a desired force of the end-effector of the robot and a differential component of the desired force. The suppressing, by using the second output signal, the vibration of the control signal for force control includes: adjusting, based on the desired force, the differential component of the desired force and the second output signal, an output displacement of the end-effector of the robot.

A third aspect of the present disclosure provides a non-temporary computer-readable storage medium storing processor-executable instructions. The processor-executable instructions, when executed by a processor, cause the processor to: acquire a first output signal of a force sensing device, the first output signal including at least one of a force signal and a torque signal; process, by an analog differential circuit, the first output signal to obtain a second output signal corresponding to a differential component of at least one of the force signal and the torque signal; and suppress, using the second output signal, vibration of a control signal for force control.

One or more embodiments of the present disclosure will be described in detail below with reference to drawings. Other features, objects and advantages of the present disclosure will become more apparent from the description, drawings, and claims.

### BRIEF DESCRIPTION OF THE DRAWINGS

In order to describe the technical solutions in the embodiments of the present disclosure more clearly, the following briefly introduces the accompanying drawings required for describing the embodiments. The accompanying drawings in the following description shows merely some embodiments of the present disclosure, and do not constitute a limitation to scope of the present disclosure.

FIG. 1 is a flow diagram illustrating a method for suppressing vibration of a control signal for force control according to an embodiment of the present disclosure.

FIG. 2 is a schematic diagram illustrating a configuration of a single channel analog differential circuit according to an embodiment of the present disclosure.

FIG. 3 is a schematic diagram illustrating an analog differential processing of signals according to an embodiment of the present disclosure.

FIG. 4 is a schematic diagram illustrating an analog differential processing; of signals according to another embodiment of the present disclosure.

FIG. 5 is a schematic diagram illustrating a vibration suppression control on a joint of a robot according to an embodiment of the present disclosure.

FIG. 6 is a schematic diagram illustrating a vibration suppression control on an end-effector of a robot according to an embodiment of the present disclosure.

FIG. 7 is a schematic diagram illustrating an internal configuration of a computer device according to an embodiment of the present disclosure.

### DETAILED DESCRIPTION OF THE EMBODIMENTS

In order to facilitate understanding of the present disclosure, the present disclosure will be described more fully below with reference to the relevant accompanying drawings. Embodiments of the present disclosure are presented in the accompanying drawings. However, the present disclosure may be implemented in many different forms and is not limited to the embodiments described herein. Rather, these embodiments are provided for the purpose of making the present disclosure more thorough and comprehensive.

Unless otherwise defined, all technical and scientific terms used herein have the same meaning as commonly understood by those skilled in the technical field to which the present disclosure belongs. The terms used herein in the specification of the disclosure are for the purpose of describing, specific embodiments only, and are not intended to limit the disclosure.

In order to make the purpose, technical solutions and advantages of the present disclosure more clearly understood, the disclosure will be further described in detail with the accompanying drawings and embodiments. It should be understood that the specific embodiments described here are only used to explain the disclosure and not to limit the disclosure.

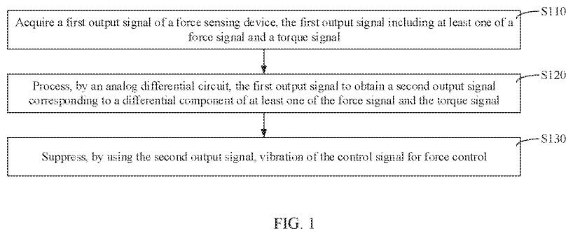

The present disclosure provides a computer-implemented method for suppressing vibration of a control signal for force control. As an example of the method applied to a robot, FIG. 1 is a flow diagram illustrating an exemplary method performed by a computing device such as a joint controller of the robot to suppress vibration of the control signal for force control in the robot. The above robot includes a plurality of joints, and a plurality of links each connected to its respective joint and driven by at least one axis motor for operation. Each axis motor is closed-loop controlled by at least one joint controller.

In step S110, a first output signal of a force sensing device is acquired. The first output signal includes at least one of a force signal and a torque signal. The first output signal including at least one of a force signal and a torque signal means the first output signal including the force signal and/or the torque signal. The force sensing device is generally mounted at each joint and an end-effector of the robot, for measuring at least one of the force signal and the torque signal at the joint or the end-effector. For measuring the force signal or torque signal, the measurement can be realized with a force sensing device including only one force sensing element or with a force sensing device including a plurality of force sensing elements, which is not limited thereto. For torque-controlled robots, each joint is generally equipped with a torque sensor, which measures the torque signal of the joint during motion. Further, the joint controller may measure the vibration at the joint by a time derivative corresponding to the torque signal. In addition, vibration at the end-effector of the robot is one of the common issues for processes where contact with the environment occurs frequently, for example, polishing, grinding and deburring. For these processes, robots need to stabilize against a high frequency disturbance while maintaining contact with a workpiece. The vibration measurement at the end-effector may be included into a robot controller. The end-effector is equipped with a force/torque sensor. Firstly, the force and torque signals of the end-effector are measured using the force/torque sensor, and then the vibration of a payload of the robot is measured by time derivatives corresponding to the force and torque signals. The force and torque signals include force signals in three orthogonal directions and torque signals in three orthogonal directions.

In step S120, the first output signal is processed by an analog differential circuit to obtain a second output signal corresponding to a differential component of at least one of the force signal and the torque signal. The differential component of the force signal is the time derivative of the force signal, and the differential component of the torque signal is the time derivative of the torque signal. In the present disclosure, the control signals for force control include control targets of force and/or torque, and control targets of differential components of force and/or torque. The corresponding differential components are obtained by pre-processing the measured force signal and/or torque signal, which are used for vibration suppression of the control signals for force control.

The above force/torque sensor generally operates by measuring deformations on a mechanical structure. When the force/torque sensor is in a multi-channel architecture, the deformations may be captured by a plurality of sensing elements simultaneously and converted into electrical signals, so that the force signal may include a plurality of measured force signals and the torque signal may include a plurality of measured torque signals. In an example, the force applied on the structure is denoted as ƒ and an analog signal output by the i-th sensing element among the n available sensing elements is denoted as xᵢ, then ƒ may be calculated by a function ƒ=g(x₁, x₂, . . . , xₙ). The function is obtained through modeling and fine-tuned during a calibration phase. Further, the time derivative of the applied force is

$$\dot{f} = {\sum }_{i = 1}^{n} \frac{\partial g ( {x}_{i} )}{\partial {x}_{i}} {\dot{x}}_{l} .$$

To calculate \dot{ƒ}, both the partial derivatives

$$\frac{\partial g ( {x}_{i} )}{\partial {x}_{i}}$$

and \dot{x}ₗ need to be calculated separately. Given an analytical model ƒ=g(x₁, x₂, . . . , xₙ), term

$$\frac{\partial g ( {x}_{i} )}{\partial {x}_{i}}$$

may be calculated and estimated for a given set of xᵢ, and term \dot{x}ₗ will need to be reliably measured or derived from xᵢ.

Typically, a computing unit such as a microprocessor used as the joint controller digitizes the analog signal xᵢ and calculates ƒ digitally in the microprocessor. If there is a need to get the \dot{x}ₗ, some digital differentiation schemes will be used. Take

$${\dot{x}}_{i} \approx \frac{{x}_{i} - {x}_{i , last}}{Δ t}$$

for example, where x_{i,last} is the last reading of xₗ digitized at a time interval Δt in the past. However, multiplying

$$\frac{1}{Δ t}$$

with (xᵢ−x_{i,last}) amplifies the noise and results in poor estimate of \dot{x}ₗ. Even though estimators and filters may be used to attenuate noise at high frequency, they often result in lag and aliasing effects which can adversely affect performance of systems using these sensors in feedback control.

Force/torque-controlled systems for robots generally require high sampling rates up to 10˜100 kHz, so the time derivatives of the force and torque acquired digitally (by finite differentiation) can be noisy due to a large amplification attributed to the high sampling rates. Take for example, consider the finite differential equation shown in the following equation:

$$Δ {f}_{i} = \frac{( {f}_{i} + {η}_{i} ) - ( {f}_{i - 1} + {η}_{i - 1} )}{Δ t ,}$$

where Δƒᵢ is the time derivative of the force signal at the i-th control cycle, ƒᵢ and ƒᵢ₋₁ are force signals at two consecutive control cycles, Δt is a sampling time, and ηᵢ and ηᵢ₋₁ are white noise signals. For a control system running at 10 kHz, the signal corruption of Δƒᵢ is equivalent to

$$\frac{{η}_{i} - {η}_{i - 1}}{Δ t} = 10000 \times ( {η}_{i} - {η}_{i - 1} ) .$$

Clearly, the residual of (ηᵢ-ηᵢ₋₁) will be amplified by 10000 times. Generally, a low-pass filter can be added to filter away the noise. Due to the large amplification, complete noise removal is very challenging. Moreover, a phase lag introduced by the filter can adversely affect a stability of the controller. To remain stable, control gains will need to be reduced to limit excitation of the noisy signals.

In present disclosure, \dot{x}ₗ is acquired by an analog differential processing of the output of the sensing element. Since the time derivative is done directly in an analog domain, it does not need to be multiplied by

$$\frac{1}{Δ t} ,$$

thereby avoiding the problem of amplification of white noise. Since analog differentiation does not amplify noise by nature, and thus the analog differentiation is independent of the selection of sampling rate. As such, the control system may be designed with a high sampling rate to achieve good damping and disturbance suppression response.

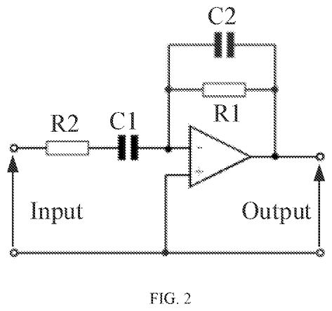

The analog differential circuit may be used for processing. The analog differential circuit may be an active or passive differentiator. The analog differential circuit may include operational amplifiers, resistors, capacitors and/or inductors. In an example, as shown in FIG. 2, a diagram illustrating a configuration of a typical single channel analog differential circuit is provided. The simplified circuit includes an operational amplifier, a first resistor R1, a second resistor R2, a first capacitor C1 and a second capacitor C2. The resistors and capacitors determine a gain and a high frequency roll off frequency. The analog differential circuit may be integrated and cooperate with the force sensing device such as the force sensor and torque sensor.

In an embodiment, when the force sensing device includes a plurality of force sensing elements and the first output signal includes a plurality of measured signals, the above step S120 may include: processing, by a plurality of analog differential circuits, the plurality of measured signals in one-to-one correspondence to obtain differential components of the plurality of measured signals; and calculating, based on the differential components of the plurality of measured signals, to determine the second output signal.

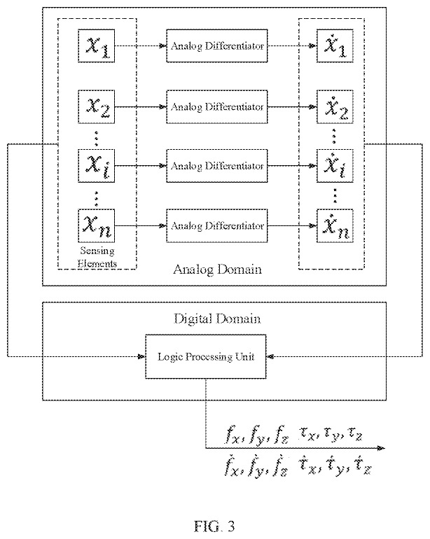

The joint controller may include an analog differentiator (i.e., the analog differential circuit described above). Since both the force signal and the torque signal include components in three orthogonal directions, there are n sets of force sensing elements in each direction that measure the same force and/or torque signal simultaneously during an actual measurement of the force sensing device. Referring to FIG. 3, a schematic diagram illustrating the analog differential processing in the analog domain of the measured signals (x₁, x₂, . . . , xᵢ, . . . , xₙ) measured by each forc^{e} sensing element separately is shown. The measured signals may refer to at least one of a force signal and a torque signal in a certain direction. After the measured signals are processed by analog differentiation of the analog differentiator, an analog differentiated signal corresponding to each measured signal may be obtained. Further, the readings of both the analog signals of the plurality of force sensing elements and the differential components (\dot{x}₁, \dot{x}₂, . . . , \dot{x}ᵢ, . . . , \dot{x}ₙ) of the analog signals may be read into a logic processing unit such as the microprocessor, a digital signal processor, or a computer processor for subsequent digital processing. Based on a signal correspondence between the force sensing device and its force sensing element, the second output signal may be determined by calculation based on the obtained differential components of the plurality of measured signals.

Taking measuring only a torque on a certain joint of the robot as an example, the torque on the joint may be measured simultaneously using n sets of torque sensing elements, so that the torque signal may include a plurality of measured torque signals, and the plurality of measured torque signals are analog signals. A calculation process is illustrated for one of the joints. Assuming that the measured torque signals output by the n sets of torque sensing elements corresponding to the joint are denoted as (τ₁, τ₂, . . . , τₙ), the joint controller will send each measured torque signal of the torque signals to the corresponding analog differentiator for the analog; differential processing, so as to obtain the respective differential components of the measured torque signals, which are denoted as (\dot{τ}₁, \dot{τ}₂, . . . , \dot{τ}ₙ). Further, the differential component of the torque signal in the corresponding direction may be calculated based on the differential components corresponding to each measured torque signal in each direction, and the differential components of the torque signals in the three orthogonal directions may be denoted as (\dot{τ}ₓ, \dot{τ}_{y}, \dot{τ}_{z}). In addition, the torque signal in the corresponding direction may be calculated based on each measured torque signal in each direction, and the torque signals in the three orthogonal directions may be denoted as (τₓ, τ_{y}, τ_{z}).

In another optional embodiment, the above step S120 may include: fusing the plurality of measured signals to obtain one or more fused measured signals; processing, by one or more analog differential circuits, the one or more fused measured signals in one-to-one correspondence to obtain differential components of the one or more fused measured signals; and calculating, based on the differential components of the one or more fused measured signals, to determine the second output signal.

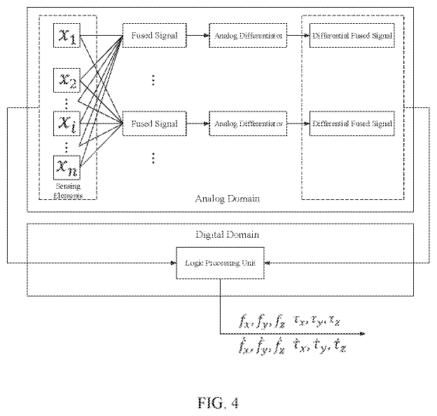

As shown in FIG. 4, it is also possible to partially or completely fuse the analog signals of the n sets of force sensing elements in the analog; domain before the analog differential processing. The number of fusion times may be one or more. Then the fused signal is input to the analog differentiator for the analog differential processing. Further, an output of the analog differentiator and an output of the force sensing element will be transferred to the logic processing unit for subsequent digital processing. Based on the signal correspondence between the force sensing device and its force sensing element, the second output signal may be determined by calculation based on the obtained differential components of the one or more fused measured signals. An example of this fusion process is a Wheatstone bridge commonly used with a strain gauge to measure deformation when a force is applied to a structure.

For example, the measured signal (x₁, x₂, . . . , xᵢ, . . . , xₙ) only indicates the measured torque signal in a certain direction and the fusion is executed multiple times. First, a plurality of measured torque signals are fused multiple times to obtain a plurality of fused measured torque signals, and then each fused measured torque signal is sent to the corresponding analog differentiator for the analog differential processing to obtain the differential components of the plurality of fused measured torque signals. Further, the differential component of the torque signal in the corresponding direction may be calculated based on the differential components corresponding to each fused measured torque signal in each direction, and the differential components of the torque signals in the three orthogonal directions may be denoted as (\dot{τ}ₓ, \dot{τ}_{y}, \dot{τ}_{z}).

In the above method of measuring the vibration of joints as well as payloads, due to the direct differentiation in the analog domain, high signal-to-noise time derivatives of the force and/or torque signals may be obtained despite a short sampling cycle. As a result, a high fidelity of the differential signals can be improved, and thus highly responsive and noise-free vibration suppression control can be realized.

In step S130, the vibration of the control signal for force control is suppressed by using the second output signal.

In an embodiment, when the first output signal indicates an outputtorque of the joint of the robot, the second output signal indicates a differential component of the output torque. The above method further includes: acquiring a desired torque of the joint of the robot and a differential component of the desired torque. For the torque-controlled joints of the robot, it is also necessary to acquire the desired torque and the differential component corresponding to the desired torque in the vibration suppression of the control signal for force control, where τ_{des} denotes the desired torque and \dot{τ}_{des} denotes the differential component of the desired torque.

Further, the above step S130 includes adjusting a motor output of the joint of the robot based on the desired torque, the differential component of the desired torque and the second output signal.

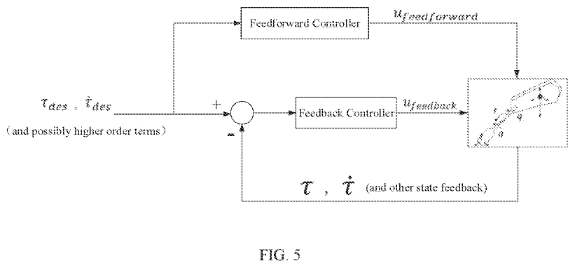

The joint controller may also include a feedforward controller and a feedback controller. Taking the calculation of a vibration compensation torque value of a certain joint in the robot as an example, the technical solution of the present disclosure is explained in combination with FIG. 5. Firstly, the joint obtains a required u_{feedforward} through the feedforward controller and follows the desired torque for the motion. The torque sensor on the joint may measure an actual torque signal (i.e., the output torque, which is denoted by τ) in the joint, and a differential component (which is denoted by \dot{τ}) of the torque signal obtained by the analog differential processing will be fed into the feedback controller. Unlimited, other state feedback quantities may also be fed into the feedback controller. Therefore, based on the desired torque, the differential component of the desired torque, the output torque and the differential component of the output torque of the joint, the feedback controller establishes a torque control model as shown in the following equation:

$$u = {u}_{feedback} + {u}_{feedforward} + {u}^{′} ,$$

where u is an output of the axis motor of the joint, u_{feedback} is an output of the feedback controller, and u_{feedforward} is an output of the feedforward controller. In an example, u_{feedforward} may be designed as the desired torque value obtained by the above calculation, i.e., u_{feedforward}=τ_{des}. The u′ includes additional terms dealing with higher order dynamics, for example, it is possible to make u′=\ddot{τ}_{des}, with \ddot{τ}_{des} being the higher order time derivative of the desired torque of the joint.

With the above closed-loop control model, the vibration compensation torque value that needs feedback may be obtained, as shown in the following equation:

$${u}_{feedback} = {K}_{T} ( {τ}_{des} - τ ) + {K}_{s} ( {\dot{τ}}_{des} - \dot{τ} ) ,$$

where K_{T} and Kₛ are both proportional gains.

The vibration suppression is performed on the control signal for force control in the joint based on the above vibration compensation torque value. The joint controller will adjust a joint torque of the corresponding axis motor based on the vibration compensation torque value corresponding to each joint for vibration compensation. In addition, a vibration compensation force value in the joint may also be calculated based on actual control needs, and a vibration suppression is performed on the corresponding control signal.

In another embodiment, when the first output signal indicates an output force of the end-effector of the robot, the second output signal indicates a differential component of the output force. The above method further includes: acquiring a desired force of the end-effector of the robot and a differential component of the desired force. It is also necessary to acquire the desired force and the differential component corresponding to the desired force in the vibration suppression of the control signal for force control on the end-effector, where F_{des} denotes the desired force and \dot{F}_{des} denotes the differential component of the desired force. In addition, some other parameters may be acquired, such as displacement, velocity, and so on. Further, the above step S130 includes adjusting an output displacement of the end-effector of the robot based on the desired force, the differential component of the desired force and the second output signal.

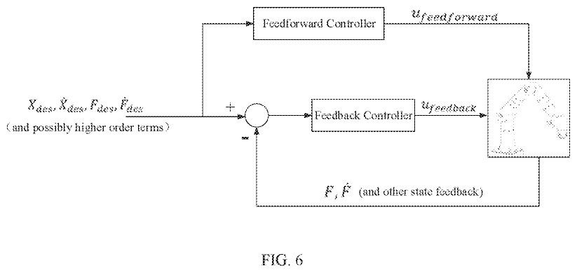

Taking the calculation of a vibration compensation force value of the end-effector of the robot as an example, as shown in FIG. 6. The end-effector obtains a required feedforward u_{feedforward} through the feedforward controller, such as a desired displacement (which is denoted by X_{des}), a desired force, or others. In motion, the force/torque sensor on the end-effector may measure an actual force signal (i.e. the output force) subjected by the robot structure, and the force signal is processed by analog differentiation to obtain a differential component (which is denoted by \dot{F}). Further, the feedback controller can operate with an error between the desired force and the output force. Generally, a proportional-integral controller is applied to the error For example, the vibration compensation force value can be obtained by adding a force damping term −K_{d}\dot{F} and a velocity damping ten −Kᵥ\dot{X}_{des} to a feedback control quantity, where K_{d} and Kᵥ are proportional gains and \dot{X}_{des} is the velocity of the end-effector. The vibration suppression is performed on the corresponding control signal for force control on the end-effector based on the obtained vibration compensation force value (i.e. u_{feedback}), and the controller will adjust the output displacement of the end-effector based on the obtained vibration compensation force value, thereby suppressing the vibration of the end of the robot.

While a variety of control schemes are available for vibration suppression, perhaps the most common and effective approach is to add a damping term, such as motor speed \dot{θ}, linkage speed \dot{q}, and a time derivative of the force, to the measurements that capture vibration. However, \dot{θ} and \dot{q} are generally derived from finite differentiation, which may generate noisy signals. In the method for suppressing the vibration of the control signal for force control provided by the present disclosure, on the one hand, the signal-to-noise time derivatives of the force and torque signals are improved due to the absence of white noise amplification that scales linearly with a sampling frequency, and since the signals have not undergone the finite differentiation and low pass filtering, the control system will not be adversely affected by phase lags if the stability of the control system is not damaged. On the other hand, since noise-free time derivatives of forces may be incorporated into a fast feedback control loop, simple but robust damping is generated, which improves a vibration suppression performance of the control signal for force control.

It should be understood that although the individual steps in the flowcharts involved in the embodiments as described above are shown sequentially as indicated by the arrows, the steps are not necessarily performed sequentially in the order indicated by the arrows. Unless explicitly stated herein, these steps are performed in no strict order and they can be performed in any other order. Moreover, at least some of the steps in the flowcharts involved in the embodiments as described above may include a plurality of steps or a plurality of stages that are not necessarily performed at the same moment of completion, but may be performed at different moments, and the order in which these steps or stages are performed is not necessarily sequential, but may be performed alternately or alternately with other steps or at least some of the steps or stages in other steps.

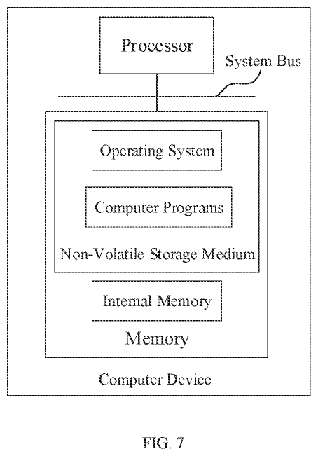

The embodiment of the present disclosure further provides a computer device. As shown in FIG. 7, the computer device includes a processor and a memory connected via a system bus, and the memory stores processor-executable instructions. The processor-executable instructions, when executed by the processor, cause the processor to: acquire a first output signal of a force sensing device, the first output signal including at least one of a force signal and a torque signal; process, by an analog differential circuit, the first output signal to obtain a second output signal corresponding to a differential component of at least one of the force signal and the torque signal; and suppress, using the second output signal, vibration of a control signal for force control.

In an embodiment, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: processing, by a plurality of analog differential circuits, the plurality of measured signals in one-to-one correspondence to obtain differential components of the plurality of measured signals; and calculating, based on the differential components of the plurality of measured signals, to determine the second output signal.

In an embodiment, the force sensing device includes a plurality of force sensing elements, and the first output signal includes a plurality of measured signals. The processing, by the analog differential circuit, the first output signal to obtain the second output signal corresponding to the differential component of at least one of the force signal and the torque signal includes: fusing the plurality of measured signals to obtain one or more fused measured signals; processing, by one or more analog differential circuits, the one or more fused measured signals in one-to-one correspondence to obtain differential components of the one or more fused measured signals; and calculating, based on the differential components of the one or more fused measured signals, to determine the second output signal.

In an embodiment, the first output signal indicates an output torque of a joint of a robot. The processor-executable instructions, when executed by the processor, further cause the processor to: acquire a desired torque of the joint of the robot and a differential component of the desired torque. The suppressing, by using the second output signal, vibration of the control signal for force control includes: adjusting, based on the desired torque, the differential component of the desired torque and the second output signal, a motor output of the joint of the robot.

In an embodiment, the first output signal indicates an output force of an end-effector of a robot. The processor-executable instructions, when executed by the processor, further cause the processor to: acquire a desired force of the end-effector of the robot and a differential component of the desired force. The suppressing, by using the second output signal, vibration of the control signal for force control includes: adjusting, based on the desired force, the differential component of the desired force and the second output signal, an output displacement of the end-effector of the robot.

The present disclosure further provides a non-temporary computer-readable storage medium storing processor-executable instructions. The processor-executable instructions, when executed by a processor, cause the processor to implement the steps in each of the method embodiments described above.

A person of ordinary skill in the art can understand that implementation of all or part of the processes in the methods of the above embodiments can be completed by instructing the relevant hardware through a computer program. The computer program may be stored in a non-volatile computer-readable storage medium. When the computer program is executed, it may include the processes in the embodiments of the above methods. Any reference to memory, database or other medium used in the embodiments provided in the present disclosure may include at least one of a non-volatile and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MARM), a ferroelectric random access memory (FRAM), a phase change memory (PCM), or a graphene memory, etc. The volatile memory may include a random access memory (RAM) or an external cache memory, etc. As an illustration rather than a limitation, the random access memory may be in various forms, such as a static random access memory (SRAM) or a dynamic random access memory (DRAM), etc. The databases involved in the embodiments provided by the present disclosure may include at least one of a relational database and a non-relational database. The non-relational database can include, without limitation, a blockchain-based distributed database, etc. The processor involved in the embodiments provided by the present disclosure may be a general purpose processor, a central processor, a graphics processor, a digital signal processor, a programmable logic device, a data processing logic device based on quantum computation, and the like, without limitation.

The technical features in the above embodiments can be combined arbitrarily. For concise description, not all possible combinations of the technical features in the above embodiments are described. However, all the combinations of the technical features are to be considered as falling within the scope described in this specification provided that they do not conflict with each other.

The above-mentioned embodiments only describe several implementations of the present disclosure, and their description is specific and detailed, but should not be understood as a limitation on the patent scope of the invention. It should be pointed out that for those skilled in the art may further make variations and improvements without departing from the conception of the present disclosure, and these all fall within the protection scope of the present disclosure. Therefore, the protection scope of the present disclosure should be subject to the appended claims.

What is claimed is:

1. A method for suppressing vibration of a control signal for force control, the method comprising:
acquiring a first output signal of a force sensing device, the first output signal comprising at least one of a force signal and a torque signal;
processing, by an analog differential circuit, the first output signal to obtain a second output signal corresponding to a differential component of at least one of the force signal and the torque signal; and
suppressing, by using the second output signal, vibration of the control signal for force control.

2. The method of claim 1, wherein the force sensing device comprises a plurality of force sensing elements, and the first output signal comprises a plurality of measured signals, and
wherein the processing, by the analog differential circuit, the first output signal to obtain the second output signal corresponding to the differential component of at least one of the force signal and the torque signal comprises:
processing, by a plurality of analog differential circuits, the plurality of measured signals in one-to-one correspondence to obtain differential components of the plurality of measured signals; and
calculating, based on the differential components of the plurality of measured signals, to determine the second output signal.

3. The method of claim 1, wherein the force sensing device comprises a plurality of force sensing elements, and the first output signal comprises a plurality of measured signals, and
wherein the processing, by the analog differential circuit, the first output signal to obtain the second output signal corresponding to the differential component of at least one of the force signal and the torque signal comprises:
fusing the plurality of measured signals to obtain one or more fused measured signals;
processing, by one or more analog differential circuits, the one or more fused measured signals in one-to-one correspondence to obtain differential components of the one or more fused measured signals; and
calculating, based on the differential components of the one or more fused measured signals, to determine the second output signal.

4. The method of claim 1, wherein the first output signal indicates an output torque of a joint of a robot, and the method further comprises:
acquiring a desired torque of the joint of the robot and a differential component of the desired torque; and
wherein the suppressing, by using the second output signal, the vibration of the control signal for force control comprises:
adjusting, based on the desired torque, the differential component of the desired torque and the second output signal, a motor output of the joint of the robot.

5. The method of claim 1, wherein the first output signal indicates an output force of an end-effector of a robot, and the method further comprises:
acquiring a desired force of the end-effector of the robot and a differential component of the desired force; and
wherein the suppressing, by using the second output signal, the vibration of the control signal for force control comprises:
adjusting, based on the desired force, the differential component of the desired force and the second output signal, an output displacement of the end-effector of the robot.

6. A computer device comprising a processor and a memory storing processor-executable instructions, wherein the processor-executable instructions, when executed by the processor, cause the processor to:
acquire a first output signal of a force sensing device, the first output signal comprising at least one of a force signal and a torque signal;
process, by an analog differential circuit, the first output signal to obtain a second output signal corresponding to a differential component of at least one of the force signal and the torque signal; and
suppressing, by using the second output signal, vibration of a control signal for force control.

7. The computer device of claim 6, wherein the force sensing device comprises a plurality of force sensing elements, and the first output signal comprises a plurality of measured signals, and
wherein the processing, by the analog; differential circuit, the first output signal to obtain the second output signal corresponding to the differential component of at least one of the force signal and the torque signal comprises:
processing, by a plurality of analog differential circuits, the plurality of measured signals in one-to-one correspondence to obtain differential components of the plurality of measured signals; and
calculating, based on the differential components of the plurality of measured signals, to determine the second output signal.

8. The computer device of claim 6, wherein the force sensing device comprises a plurality of force sensing elements, and the first output signal comprises a plurality of measured signals, and
wherein the processing, by the analog differential circuit, the first output signal to obtain the second output signal corresponding to the differential component of at least one of the force signal and the torque signal comprises:
fusing the plurality of measured signals to obtain one or more fused measured signals;
processing, by one or more analog; differential circuits, the one or more fused measured signals in one-to-one correspondence to obtain differential components of the one or more fused measured signals; and
calculating, based on the differential components of the one or more fused measured signals, to determine the second output signal.

9. The computer device of claim 6, wherein the first output signal indicates an output force of an end-effector of a robot, and the processor-executable instructions, when executed by the processor, further cause the processor to:
acquire a desired torque of the joint of the robot and a differential component of the desired torque; and
wherein the suppressing, by using; the second output signal, the vibration of the control signal for force control comprises:
adjusting, based on the desired torque, the differential component of the desired torque and the second output signal, a motor output of the joint of the robot.

10. The computer device of claim 6, wherein the first output signal indicates an output force of an end-effector of a robot, and the processor-executable instructions, when executed by the processor, further cause the processor to:
acquire a desired force of the end-effector of the robot and a differential component of the desired force, and
wherein the suppressing, by using the second output signal, the vibration of the control signal for force control comprises:
adjusting, based on the desired force, the differential component of the desired force and the second output signal, an output displacement of the end-effector of the robot.

11. A non-temporary computer-readable storage medium storing processor-executable instructions, wherein the processor-executable instructions, when executed by a processor, cause the processor to:
acquire a first output signal of a force sensing device, the first output signal comprising at least one of a force signal and a torque signal;
process, by an analog differential circuit, the first output signal to obtain a second output signal corresponding to a differential component of at least one of the force signal and the torque signal; and
suppressing, by using the second output signal, vibration of a control signal for force control.
